(19) United States
(12) Patent Application Publication
(10) Pub. No.: US 2026/0046095 A1
(43) Pub. Date: Feb. 12, 2026

(54) Secure and Fast Groupcast

(71) Applicant: Apple Inc., Cupertino, CA (US)

(72) Inventors: Yanjun Sun, San Diego, CA (US); Abdel Karim Ajami, San Jose, CA (US); Anuj Batra, Redwood City, CA (US); Charles F Dominguez, San Carlos, CA (US); Jarkko L Kneckt, Los Gatos, CA (US); Leonid Epstein, Netanya (IL); Morteza Mehrnoush, Hayward, CA (US); Oren Shani, Saratoga, CA (US); Wook Bong Lee, San Jose, CA (US); Yoel Boger, Shoham (IL); Yong Liu, Campbell, CA (US)

(21) Appl. No.: 19/291,872

(22) Filed: Aug. 6, 2025

Related U.S. Application Data
(60) Provisional application No. 63/681,632, filed on Aug. 9, 2024.

(51) Int. Cl. H04L 5/00; H04L 1/00; H04W 12/106

(52) U.S. Cl. CPC H04L 5/0053; H04L 1/0008; H04W 12/106

(57) ABSTRACT

An electronic device is described. This electronic device can include: an antenna node communicatively coupled to an antenna; and an interface circuit, communicatively coupled to the antenna node, that communicates with a second electronic device. During operation, the interface circuit can provide, addressed to at least the second electronic device, a groupcasting with retries (GCR) block acknowledgment request (BAR), where the GCR BAR indicates that the GCR BAR is protected. Note that the GCR BAR can include a GCR multi-user BAR (MU-BAR). Moreover, the indication can be included in a reserved bit in the GCR BAR. For example, the reserved bit can include bit 0 or at least one of bits 5-11 in a BAR control field. Furthermore, the GCR BAR can indicate a key identifier using the reserved bit.

### CROSS-REFERENCE TO RELATED APPLICATION

This application claims the benefit of U.S. Provisional Application No. 63/681,632, entitled “Secure and Fast Groupcast,” by Yanjun Sun, et al., filed Aug. 9, 2024, the contents of which are hereby incorporated by reference.

### FIELD

The described embodiments relate, generally, to wireless communication among electronic devices, including secure and fast groupcast.

### BACKGROUND

Many electronic devices communicate with each other using wireless local area networks (WLANs), such as those based on a communication protocol that is compatible with an Institute of Electrical and Electronics Engineers (IEEE) 802.11 standard (which is sometimes referred to as ‘Wi-Fi’).

In order to protect Wi-Fi communication, protection is being added to control frames and media access control (MAC) headers of unicast data and management frames. However, group-addressed frames (such as those associated with groupcasting with retries or GCR, which is a service for robust audio/video streaming) are not protected.

In an attack, an attacker can move the block acknowledgment window to cause data loss at one or more receivers. For example, fake GCR multi-user-block acknowledgment request (MU-BAR) or data can be injected with an invalid sequence number (SN), which can befoul or otherwise corrupt the scoreboard and/or can corrupt the reorder buffer. This may prevent the incorrect ordering of the frames and/or can obstruct the recovery of the associated content.

### SUMMARY

In a first group of embodiments, an electronic device is described. This electronic device includes: an antenna node communicatively coupled to an antenna; and an interface circuit, communicatively coupled to the antenna node, that communicates with a second electronic device. During operation, the interface circuit provides, addressed to at least the second electronic device, a groupcasting with retries (GCR) block acknowledgment request (BAR), where the GCR BAR indicates that the GCR BAR is protected.

Note that the GCR BAR can include a GCR multi-user BAR (MU-BAR).

Moreover, the indication can be included in a reserved bit in the GCR BAR. For example, the reserved bit can include bit 0 or at least one of bits 5-11 in a BAR control field. Furthermore, the GCR BAR can indicate a key identifier using the reserved bit.

Additionally, the GCR BAR can include a packet number (PN) and a message integrity check (MIC). For example, the PN and the MIC can be included in a BAR information field after a GCR group address or after the BAR information field. Note that the BAR information field can include padding after the MIC.

In some embodiments, the interface circuit receives, associated with the second electronic device, a multi-station block acknowledgment (M-BA). This M-BA can be protected. Note that the M-BA can include a per association identifier (AID) traffic identifier (TID) information field identified by a reserved value in an AID TID information subfield and the per AID TID information subfield can include information associated with GCR. The information can include a GCR group address and/or TID information.

Moreover, the second electronic device can be a member in a GCR group.

Furthermore, the interface circuit can provide, addressed to at least the second electronic device and before the GCR BAR, an initial control frame (ICF). The ICF can include information about one or more MAC headers of one or more subsequent GCR data frames. For example, the information can include: a valid sequence number (SN) range, a power-management bit, a more data bit, an end of service period (EOSP) bit, or a high throughput (HT)-control field of one or more MAC headers. Additionally, the interface circuit can receive, associated with the second electronic device and in response to the ICF, an initial control response (ICR) or ICR frame. The ICR can be protected. Note that the ICF can include: a multi-user request-to-send frame, a buffer status report poll (BSRP), a trigger frame, a BAR frame, a block acknowledgment frame or another control frame. In some embodiments, the ICF can be included in an aggregate-MAC protocol data unit (A-MPDU). The ICF can be unicast and can be protected using a key for a GCR group that includes the second electronic device. Moreover, a receiver address (RA) for the ICF or a user information field in the ICF can include a group address of the GCR group.

The GCR BAR can include information about one or more MAC headers of one or more subsequent GCR data frames and the information can include: a valid SN range, a power-management bit, a more data bit, an EOSP bit, or a HT-control field of one or more MAC headers.

Other embodiments provide the second electronic device that performs counterpart operations to at least some of the operations performed by the electronic device. For example, the second electronic device can include: an antenna node communicatively coupled to an antenna; and an interface circuit, communicatively coupled to the antenna node, that communicates with the electronic device. During operation, the interface circuit receives, associated with the electronic device, a GCR BAR, where the GCR BAR indicates that the GCR BAR is protected.

Moreover, the interface circuit can provide, addressed to the electronic device, an M-BA. The M-BA can be protected.

Furthermore, the interface circuit can validate the one or more GCR data frames based at least in part on the information. For example, the validation can be based at least in part on a MIC of an ICF.

Other embodiments provide an integrated circuit (such as the interface circuit) for use with the electronic device or the second electronic device. The integrated circuit can perform at least some of the aforementioned operations.

Other embodiments provide a computer-readable storage medium for use with the electronic device or the second electronic device. When program instructions stored in the computer-readable storage medium are executed by the electronic device or the second electronic device, the program instructions can cause the electronic device or the second electronic device to perform at least some of the aforementioned operations of the electronic device or the second electronic device.

Other embodiments provide a method. The method includes at least some of the aforementioned operations performed by the electronic device or the second electronic device.

In a second group of embodiments, an electronic device is described. This electronic device includes: an antenna node communicatively coupled to an antenna; and an interface circuit, communicatively coupled to the antenna node, that communicates with a second electronic device. During operation, the interface circuit provides, addressed to the second electronic device, information that indicates the second electronic device remains on an enhanced multi-link single radio (eMLSR) link.

Note that the information can include: a duration during which the second electronic device remains on the eMLSR link; an end of a physical layer protocol data unit (PPDU) for coordination transmission; an end of a current transmit opportunity (TXOP); or an indication that the second electronic device needs to wait for another frame addressed at least to the second electronic device before the end of the current TXOP. For example, the indication can include a flag in an ICF. In some embodiments, the information can be included in: a trigger frame; or an aggregated-control (A-control) field of a data or a management frame.

Other embodiments provide an integrated circuit (such as the interface circuit) for use with the electronic device or the second electronic device. The integrated circuit can perform at least some of the aforementioned operations.

Other embodiments provide the second electronic device that performs counterpart operations to at least some of the operations performed by the electronic device. For example, the second electronic device can include: an antenna node communicatively coupled to an antenna; and an interface circuit, communicatively coupled to the antenna node, that communicates with the electronic device. During operation, the interface circuit receives, associated with the electronic device, information that indicates the second electronic device remains on an eMLSR link.

Note that the second electronic device can remain on the eMLSR link for a predefined threshold time. When no indication of an incoming PPDU addressed to the second electronic device is detected at the end of the predefined threshold time, the interface circuit can switch to a listening operation.

Other embodiments provide a computer-readable storage medium for use with the electronic device or the second electronic device. When program instructions stored in the computer-readable storage medium are executed by the electronic device or the second electronic device, the program instructions can cause the electronic device or the second electronic device to perform at least some of the aforementioned operations of the electronic device or the second electronic device.

Other embodiments provide a method. The method includes at least some of the aforementioned operations performed by the electronic device or the second electronic device.

In a third group of embodiments, an electronic device is described. This electronic device includes: an antenna node communicatively coupled to an antenna; and an interface circuit, communicatively coupled to the antenna node, that communicates with a second electronic device. During operation, the interface circuit determines that the second electronic device is busy, using peer-to-peer communication, on a first eMLSR link. Then, while the second electronic device is busy on the first eMLSR link, the interface circuit blocks transmission to or reception from the second electronic device using a second eMLSR link.

Note that, before transmitting a data frame on a given eMLSR link that includes the first eMLSR link or the second eMLSR link, the interface circuit can provide, addressed to the second electronic device, an ICF.

Other embodiments provide an integrated circuit (such as the interface circuit) for use with the electronic device or the second electronic device. The integrated circuit can perform at least some of the aforementioned operations.

Other embodiments provide the second electronic device. For example, the second electronic device can include: an antenna node communicatively coupled to an antenna; and an interface circuit, communicatively coupled to the antenna node, that communicates with the electronic device. During operation, the interface circuit determines that the electronic device is busy, using peer-to-peer communication, on a first eMLSR link. Then, while the electronic device is busy on the first eMLSR link, the interface circuit blocks transmission to or reception from the electronic device using a second eMLSR link.

Note that, before receiving data frame on a given eMLSR link that includes the first eMLSR link or the second eMLSR link, the interface circuit can receive, associated with the electronic device, an ICF and can respond with an ICR.

Other embodiments provide a computer-readable storage medium for use with the electronic device or the second electronic device. When program instructions stored in the computer-readable storage medium are executed by the electronic device or the second electronic device, the program instructions can cause the electronic device or the second electronic device to perform at least some of the aforementioned operations of the electronic device or the second electronic device.

Other embodiments provide a method. The method includes at least some of the aforementioned operations performed by the electronic device or the second electronic device.

This Summary is provided for purposes of illustrating some exemplary embodiments, so as to provide a basic understanding of some aspects of the subject matter described herein. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The included drawings are for illustrative purposes and serve only to provide examples of possible structures and arrangements for the disclosed systems and techniques for intelligently and efficiently managing communication between multiple associated user devices. These drawings in no way limit any changes in form and detail that can be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 is a block diagram illustrating an example of communication between electronic devices.

FIG. 2 is a block diagram illustrating an example of communication between electronic devices.

FIG. 3 is a flow diagram illustrating an example method for providing a GCR BAR using an electronic device of FIG. 1 or 2.

FIG. 4 is a flow diagram illustrating an example method for receiving a GCR BAR using the electronic device of FIG. 1 or 2.

FIG. 5 is a drawing illustrating an example of communication between the electronic devices of FIG. 1 or 2.

FIG. 6 is a flow diagram illustrating an example method for providing information using an electronic device of FIG. 1 or 2.

FIG. 7 is a flow diagram illustrating an example method for receiving information using the electronic device of FIG. 1 or 2.

FIG. 8 is a drawing illustrating an example of communication between the electronic devices of FIG. 1 or 2.

FIG. 9 is a flow diagram illustrating an example method for selectively blocking transmission to or reception from a second electronic device using an electronic device of FIG. 1 or 2.

FIG. 10 is a drawing illustrating an example of communication between the electronic devices of FIG. 1 or 2.

FIG. 11 is a drawing illustrating existing communication between electronic devices.

FIG. 12 is a drawing illustrating an example of communication between the electronic devices of FIG. 1 or 2.

FIG. 13 is a drawing illustrating an example of a protected GCR BAR or GCR MU-BAR.

FIG. 14 is a drawing illustrating an example of a protected GCR BAR or GCR MU-BAR.

FIG. 15-18 are drawings illustrating examples of communication between electronic devices.

FIG. 19 is a drawing illustrating existing communication between electronic devices.

FIG. 20-22 are drawings illustrating examples of communication between electronic devices.

FIG. 23 illustrates an example of an electronic device of FIG. 1 according to some embodiments of the disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, an electronic device is described. This electronic device can include: an antenna node communicatively coupled to an antenna; and an interface circuit, communicatively coupled to the antenna node, that communicates with a second electronic device. During operation, the interface circuit can provide, addressed to at least the second electronic device, a GCR BAR, where the GCR BAR indicates that the GCR BAR is protected. Note that the GCR BAR can include a GCR MU-BAR.

By protecting the GCR BAR frame, these communication techniques can improve the security of these group-addressed frames. These capabilities can prevent an attacker from injecting data with an invalid SN and/or corrupting the scoreboard or the reorder buffer. Consequently, the communication techniques can prevent the incorrect ordering of the frames and/or can aid in the recovery of the associated content. In these ways, the communication techniques can improve the user experience when using the electronic device and/or the second electronic device.

Moreover, in a second group of embodiments, an electronic device is described. This electronic device can include: an antenna node communicatively coupled to an antenna; and an interface circuit, communicatively coupled to the antenna node, that communicates with a second electronic device. During operation, the interface circuit can provide, addressed to the second electronic device, information that indicates the second electronic device remains on an eMLSR link. Note that the information can include: a duration during which the second electronic device remains on the eMLSR link; an end of a PPDU for coordination transmission; an end of a current TXOP; or an indication that the second electronic device needs to wait for another frame addressed at least to the second electronic device before the end of the current TXOP.

By communicating the information, these communication techniques can ensure that the second electronic device can take advantage of the low-latency benefit of eMLSR operation. Notably, the communication techniques can ensure that the second electronic device remains on the eMLSR link for a predefined time. Consequently, the communication techniques can help ensure predictable operation and performance of the eMLSR link, e.g., by preventing the second electronic device from switching back to a listening operation prematurely. In these ways, the communication techniques can improve the user experience when using the electronic device and/or the second electronic device.

In a third group of embodiments, an electronic device is described. This electronic device can include: an antenna node communicatively coupled to an antenna; and an interface circuit, communicatively coupled to the antenna node, that communicates with a second electronic device. During operation, the interface circuit can determine that the second electronic device is busy, using peer-to-peer communication, on a first eMLSR link. Then, while the second electronic device is busy on the first eMLSR link, the interface circuit can block transmission to or reception from the second electronic device using a second eMLSR link. Note that, before transmitting a data frame on a given eMLSR link that includes the first eMLSR link or the second eMLSR link, the interface circuit can provide, addressed to the second electronic device, an ICF.

By determining that the second electronic device is busy, these communication techniques can ensure that communication with the second electronic device (e.g., via the eMLSR link) is robust and reliable. Consequently, the communication techniques can help ensure predictable operation and performance of the communication with the second electronic device. In these ways, the communication techniques can improve the user experience when using the electronic device and/or the second electronic device.

In the discussion that follows, a user can include: an individual, an organization, a company, a governmental agency, a for-profit business entity, a not-for-profit entity, or a group of one or more individuals.

Note that the communication techniques can be used during or with wired or wireless communication between electronic devices in accordance with a communication protocol, such as a communication protocol that is compatible with an IEEE 802.11 standard (which is sometimes referred to as Wi-Fi). However, the communication techniques can also be used with a wide variety of other communication protocols, and in electronic devices (such as portable electronic devices or mobile devices) that can incorporate multiple different radio access technologies (RATs) to provide connections through different wireless networks that offer different services and/or capabilities.

The electronic device and/or the second electronic device can include hardware and software to support a wireless personal area network (WPAN) according to a WPAN communication protocol, such as those standardized by the Bluetooth Special Interest Group and/or those developed by Apple (in Cupertino, California) that are referred to as an Apple Wireless Direct Link (AWDL). Moreover, the electronic device and/or the second electronic device can communicate via: a wireless wide area network (WWAN), a wireless metro area network (WMAN), a WLAN, near-field communication (NFC), a cellular-telephone or data network (such as using a third generation (3G) communication protocol, a fourth generation (4G) communication protocol, e.g., Long Term Evolution or LTE, LTE Advanced (LTE-A), a fifth generation (5G) communication protocol, or other present or future developed advanced cellular communication protocol) and/or another communication protocol. In some embodiments, the communication protocol includes a peer-to-peer communication technique.

The electronic device and/or the second electronic device, in some embodiments, can also operate as part of a wireless communication system, which can include a set of client devices, which can also be referred to as stations or client electronic devices, interconnected to an access point, e.g., as part of a WLAN, and/or to each other, e.g., as part of a WPAN and/or an ‘ad hoc’ wireless network, such as a Wi-Fi direct connection. In some embodiments, the client device can be any electronic device that is capable of communicating via a WLAN technology, e.g., in accordance with a WLAN communication protocol. Furthermore, in some embodiments, the WLAN technology can include a Wi-Fi (or more generically a WLAN) wireless communication subsystem or radio, and the Wi-Fi radio can implement an IEEE 802.11 technology, such as one or more of: IEEE 802.11a; IEEE 802.11b; IEEE 802.11g; IEEE 802.11-2007; IEEE 802.11n; IEEE 802.11-2012; IEEE 802.11-2016; IEEE 802.11ac; IEEE 802.11ax, IEEE 802.11ba, IEEE 802.11be, IEEE 802.11me, IEEE 802.11bn, IEEE 802.11bx, IEEE 802.11mf or other present or future developed IEEE 802.11 technologies.

Note that the electronic device and/or the second electronic device can use multi-user transmission (such as OFDMA) and/or multiple-input multiple-output (MIMO).

In some embodiments, the electronic device and/or the second electronic device can act as a communications hub that provides access to a WLAN and/or to a WWAN and, thus, to a wide variety of services that can be supported by various applications executing on the electronic device and/or the second electronic device. Thus, the electronic device and/or the second electronic device can include an ‘access point’ that communicates wirelessly with other electronic devices (such as using Wi-Fi), and that provides access to another network (such as the Internet) via IEEE 802.3 (which is sometimes referred to as ‘Ethernet’). Note that the access point can be a physical access point or a virtual or ‘software’ access point that is implemented on a computer or an electronic device. However, in other embodiments the electronic device and/or the second electronic device may not be an access point.

Additionally, it should be understood that the electronic devices described herein can be configured as multi-mode wireless communication devices that are also capable of communicating via different 3G and/or second generation (2G) RATs. In these scenarios, a multi-mode electronic device or UE can be configured to prefer attachment to LTE networks offering faster data rate throughput, as compared to other 3G legacy networks offering lower data rate throughputs. For example, in some implementations, a multi-mode electronic device is configured to fall back to a 3G legacy network, e.g., an Evolved High Speed Packet Access (HSPA+) network or a Code Division Multiple Access (CDMA) 2000 Evolution-Data Only (EV-DO) network, when LTE and LTE-A networks are otherwise unavailable. More generally, the electronic devices described herein can be capable of communicating with other present or future developed cellular-telephone technologies.

In accordance with various embodiments described herein, the terms ‘wireless communication device,’ ‘electronic device,’ ‘mobile device,’ ‘mobile station,’ ‘wireless station, ’ ‘wireless access point,’ ‘station,’ ‘access point’ and ‘user equipment’ (UE) can be used herein to describe one or more consumer electronic devices that can be capable of performing procedures associated with various embodiments of the disclosure.

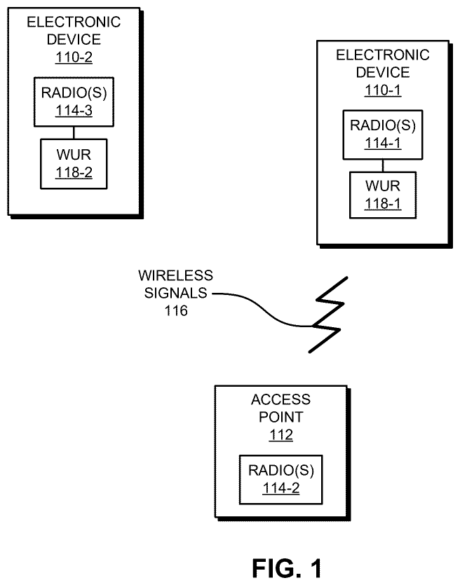

FIG. 1 presents a block diagram illustrating an example of electronic devices communicating wirelessly. Notably, one or more electronic devices 110 (such as a smartphone, a laptop computer, a notebook computer, a tablet, or another such electronic device) and access point 112 can communicate wirelessly in a WLAN using an IEEE 802.11 communication protocol. Thus, electronic devices 110 can be associated with or can have one or more connections with access point 112. For example, electronic devices 110 and access point 112 can wirelessly communicate while: detecting one another by scanning wireless channels, transmitting and receiving beacons or (equivalently) beacon frames on wireless channels, establishing connections (for example, by transmitting connect requests), and/or transmitting and receiving packets or frames (which can include the request and/or additional information, such as data, as payloads). Note that access point 112 can provide access to a network, such as the Internet, via an Ethernet protocol, and can be a physical access point or a virtual or ‘software’ access point that is implemented on a computer or an electronic device. In the discussion that follows, electronic devices 110 are sometimes referred to as ‘clients,’ ‘stations,’ or ‘recipient electronic devices.’

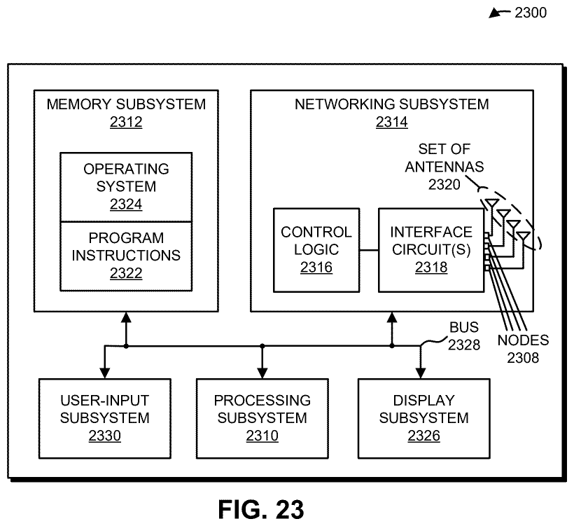

As described further below with reference to FIG. 23, electronic devices 110 and access point 112 can include subsystems, such as a networking subsystem, a memory subsystem, and a processor subsystem. In addition, electronic devices 110 and access point 112 can include radios 114 in the networking subsystems. More generally, electronic devices 110 and access point 112 can include (or can be included within) any electronic devices with networking subsystems that enable electronic devices 110 and access point 112, respectively, to wirelessly communicate with another electronic device. This can include transmitting beacon frames on wireless channels to enable the electronic devices to make initial contact with or to detect each other, followed by exchanging subsequent data/management frames (such as connect requests) to establish a connection, configure security options (e.g., IPSec), transmit and receive packets or frames via the connection, etc.

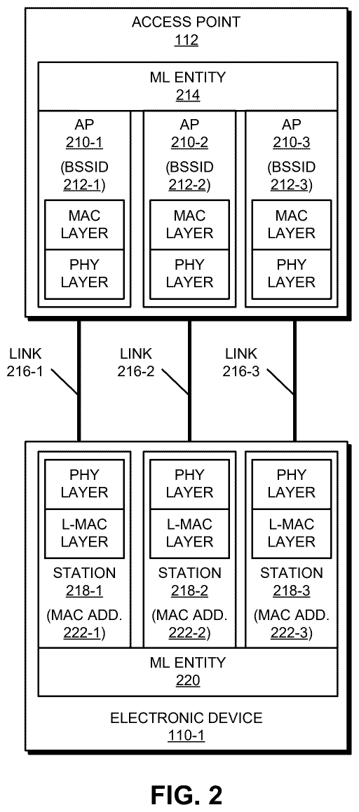

As can be seen in FIG. 1, wireless signals 116 (represented by a jagged line) are communicated by one or more radios 114-1 and 114-2 in electronic device 110-1 and access point 112, respectively. For example, as noted previously, electronic device 110-1 and access point 112 can exchange packets or frames using a Wi-Fi communication protocol in a WLAN. As illustrated further below with reference to FIGS. 2-22, one or more radios 114-1 can receive wireless signals 116 that are transmitted by one or more radios 114-2 via one or more links between electronic device 110-1 and access point 112. Alternatively, the one or more radios 114-1 can transmit wireless signals 116 that are received by the one or more radios 114-2.

In some embodiments, wireless signals 116 are communicated by one or more radios 114 in electronic devices 110 and access point 112, respectively. For example, one or more radios 114-1 and 114-3 can receive wireless signals 116 that are transmitted by one or more radios 114-2 via one or more links between electronic devices 110-1 and 110-2, and access point 112.

Note that the one or more radios 114-1 can consume additional power in a higher-power mode. If the one or more radios 114-1 remain in the higher-power mode even when they are not transmitting or receiving packets or frames, the power consumption of electronic device 110-1 can be needlessly increased. Consequently, electronic devices 110 can include wake-up radios (WURs) 118 that listen for and/or receive wake-up frames (and/or other wake-up communications), e.g., from access point 112. When a particular electronic device (such as electronic device 110-1) receives a wake-up frame, WUR 118-1 can selectively wake-up radio 114-1, e.g., by providing a wake-up signal that selectively transitions at least one of the one or more radios 114-1 from a lower-power mode to the higher-power mode.

IEEE 802.11be has proposed the use of multiple concurrent links between electronic devices, such as access point 112 and one or more of electronic device 110. For example, as shown in FIG. 2, which presents a block diagram illustrating an example of electronic devices communicating wirelessly, access point 112 can be an access point multi-link device (MLD) that includes multiple access points 210, which are cohosted or collocated in access point 112. In the present discussion, ‘cohosted’ or ‘collocated’ means that access points 210 are physically or virtually implemented in the same access point MLD, or are affiliated with the same access point MLD. Note that this meaning of ‘cohosted’ does not indicate that access points 210 have the same primary 20 MHz channel. Access points 210 can have associated basic service set identifiers (BSSIDs) 212, and media access control (MAC) and physical (PHY) layers (including separate radios, which can be included in the same or different integrated circuits). Note that access point 112 can have an ML entity 214 having an MLD MAC address, an ML identifier, a service set identifier (SSID), and that can provide security for access points 210.

Moreover, access points 210 can have different concurrent links 216 in different bands of frequencies (such as a link 216-1 with a link identifier 1 in a 2.4 GHz band of frequencies, a link 216-2 with a link identifier 2 in a 5 GHz band of frequencies and a link 216-3 with a link identifier 3 in a 6 GHz bands of frequencies) with stations 218 in at least electronic device 110-1, which is a non-access point MLD. These stations can have associated lower MAC and PHY layers (including separate radios, which can be included in the same or different integrated circuits). In addition, electronic device 110-1 can have an ML entity 220 having an MLD MAC address.

For example, the access point MLD can have three radios. One radio can operate on a 2.4 GHz band of frequencies, and the other radios can operate on the 5/6 GHz bands of frequencies. The access point MLD can create three access points 210, operating on a 2.4 GHz channel, a 5 GHz channel, and a 6 GHz channel respectively. The three access points 210 can operate independently, each of which has at least one BSS with different BSSIDs 212. (While FIG. 2 illustrates the access point MLD with three access points 210, more generally the access point MLD can include up to 15 access points with one or more access points in a given band of frequencies.) Moreover, each of the access points 210 can accommodate both legacy non-access point stations as well as non-access point MLD stations 218. Furthermore, each of access points 210 can transmit its own beacon frames using its own BSSID. Additionally, the access point MLD can have ML entity 214, identified by an MLD address (such as an MLD MAC address). This MAC address can be used to pair with ML entity 220 of the associated non-access point MLD stations 218.

Moreover, the non-access point MLD station (e.g., electronic device 110-1) can have two or three radios. One radio can operate on a 2.4 GHz band of frequencies, and the other radios can operate on the 5/6 GHz bands of frequencies. When the non-access point MLD establishes a ML association with the access point MLD, it can create up to three stations 218, each of which associates to one of access points 210 within the access point MLD. Each of stations 218 can have a different over-the-air MAC address 222. The non-access point MLD can also have ML entity 220, identified by another MLD address (such as another MLD MAC address). This MLD MAC address can be used to pair with ML entity 214 of the associated access point MLD.

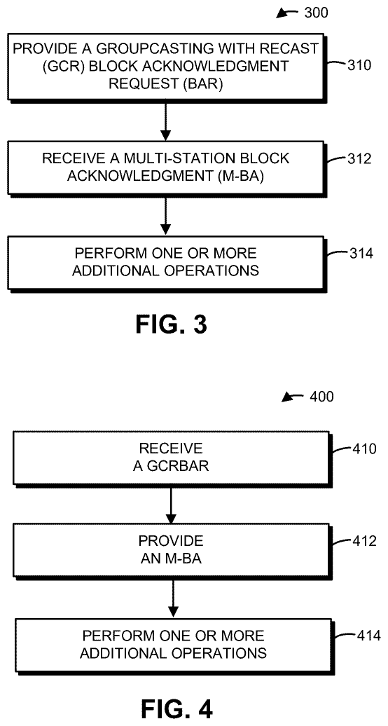

Referring back to FIG. 1, as noted previously, existing communication techniques may not protect GCR BAR frames. In order to address these problems, as described further below with reference to FIGS. 3-22, in the communication techniques access point 112 and/or electronic device 110-1 can perform the communication techniques.

Notably, access point 112 can provide, addressed to at least electronic device 110-1, a GCR BAR, where the GCR BAR indicates that the GCR BAR is protected. For example, the GCR BAR can include a GCR MU-BAR. Note that electronic device 110-1 can be a member in a GCR group.

This GCR BAR can be received by electronic device 110-1. Then, electronic device 110-1 can provide, addressed to access point 112, an M-BA. This M-BA can be protected. Then, access point 112 can receive the M-BA. Note that the M-BA can include a per AID TID information field identified by a reserved value in an AID TID information subfield and the per AID TID information subfield can include information associated with GCR. The information can include a GCR group address and/or TID information.

In some embodiments, access point 112 can provide, addressed to at least electronic device 110-1 and before the GCR BAR, an ICF. The ICF can include information about one or more MAC headers of one or more subsequent GCR data frames. For example, the information can include: a valid SN range, a power-management bit, a more data bit, an EOSP bit, or a HT-control field of one or more MAC headers. Additionally, access point 112 can receive, associated with electronic device 110-1 and in response to the ICF, an ICR. The ICR can be protected. Note that the ICF can include: a multi-user request-to-send frame, a BSRP, a trigger frame, a BAR frame, a block acknowledgment frame or another control frame. In some embodiments, the ICF can be included in an A-MPDU. The ICF can be unicast and can be protected using a key for a GCR group that includes electronic device 110-1. Moreover, an RA for the ICF or a user information field in the ICF can include a group address of the GCR group.

Moreover, the GCR BAR can include information about one or more MAC headers of one or more subsequent GCR data frames and the information can include: a valid SN range, a power-management bit, a more data bit, an EOSP bit, or a HT-control field of one or more MAC headers.

In some embodiments, electronic device 110-1 can validate one or more GCR data frames based at least in part on the information. For example, the validation can be based at least in part on a MIC of an ICF.

Alternatively or additionally, access point 112 can provide, addressed to electronic device 110-1, information that indicates the second electronic device remains on an eMLSR link. This information can be received by electronic device 110-1.

Note that the information can include: a duration during which the second electronic device remains on the eMLSR link; an end of a PPDU for coordination transmission; an end of a current TXOP; or an indication that electronic device 110-1 needs to wait for another frame addressed at least to electronic device 110-1 before the end of the current TXOP. For example, the indication can include a flag in an ICF. In some embodiments, the information can be included in: a trigger frame; or an A-control field of a data or a management frame.

In some embodiments, electronic device 110-1 can remain on the eMLSR link for a predefined threshold time. When no indication of an incoming PPDU addressed to electronic device 110-1 is detected at the end of the predefined threshold time, electronic device 110-1 can switch to a listening operation.

Alternatively or additionally, access point 112 determine that electronic device 110-1 is busy, using peer-to-peer communication, on a first eMLSR link. Then, while electronic device 110-1 is busy on the first eMLSR link, access point 112 can block transmission to or reception from electronic device 110-1 using a second eMLSR link.

Note that, before transmitting a data frame on a given eMLSR link that includes the first eMLSR link or the second eMLSR link, access point 112 can provide, addressed to electronic device 110-1, an ICF.

In some embodiments, instead of access point 112 determining that electronic device 110-1 is busy, electronic device 110-1 can determine that access point 112 is busy, using peer-to-peer communication, on a first eMLSR link. Then, while access point 112 is busy on the first eMLSR link, electronic device 110-1 blocks transmission to or reception from access point 112 using a second eMLSR link.

Note that, before receiving data frame on a given eMLSR link that includes the first eMLSR link or the second eMLSR link, electronic device 110-1 can receive, associated with access point 112, an ICF and can respond with an ICR.

In summary, the disclosed communication techniques can facilitate improved communication between access point 112 and electronic device 110-1. For example, the communication techniques can improve the security of group-addressed frames, such as the GCR BAR. Moreover, the communication techniques can ensure that electronic device 110-1 remains on the eMLSR link for a predefined time. Furthermore, the communication techniques can ensure that communication with electronic device 110-1 (e.g., via the eMLSR link) is robust and reliable. Consequently, the communication techniques can help ensure predictable operation and performance of the communication with access point 112 and electronic device 110-1. In these ways, the communication techniques can improve the user experience and customer satisfaction when using access point 112 and/or electronic device 110-1.

While the preceding discussion illustrated communication by access point 112 to electronic device 110-1, in other embodiments the roles of access point 112 and electronic device 110-1 can be reversed in the communication techniques. For example, electronic device 110-1 can include a second access point and access point 112 can be a second electronic device which is a station or client that is associated with the second access point. Alternatively, in some embodiments, the communication techniques are performed between electronic device 110-1 and electronic device 110-2.

Note that access point 112 and one or more electronic devices (such as electronic devices 110-1 and/or 110-2) can be compatible with an IEEE 802.11 standard that includes trigger-based channel access (such as IEEE 802.11ax). However, access point 112 and the one or more electronic devices can also communicate with one or more legacy electronic devices that are not compatible with the IEEE 802.11 standard (i.e., that do not use multi-user trigger-based channel access). In some embodiments, access point 112 and the one or more electronic devices use multi-user transmission (such as OFDMA). For example, the one or more radios 114-2 can provide one or more trigger frames for the one or more electronic devices. Moreover, in response to receiving the one or more trigger frames, the one or more radios 114-1 can provide one or more group or block acknowledgments to the one or more radios 114-2. For example, the one or more radios 114-1 can provide the one or more group acknowledgments during associated assigned time slot(s) and/or in an assigned channel(s) in the one or more group acknowledgments. However, in some embodiments one or more of electronic devices 110 can individually provide acknowledgments to the one or more radios 114-2. Thus, the one or more radios 114-1 (and, more generally, radios 114 in the electronic devices 110-1 and/or 110-2) can provide one or more acknowledgments to the one or more radios 114-2.

In the described embodiments, processing a packet or frame in one of electronic devices 110 and access point 112 includes: receiving wireless signals 116 encoding a packet or a frame; decoding/extracting the packet or frame from received wireless signals 116 to acquire the packet or frame; and processing the packet or frame to determine information contained in the packet or frame (such as data in the payload).

In general, the communication via the WLAN in the communication techniques can be characterized by a variety of communication-performance metrics. For example, the communication-performance metric can include one or more of: an RSSI, a data rate, a data rate for successful communication (which is sometimes referred to as a ‘throughput’), a latency, an error rate (such as a retry or resend rate), a mean-square error of equalized signals relative to an equalization target, inter-symbol interference, multipath interference, a signal-to-noise ratio (SNR), a width of an eye pattern, a ratio of a number of bytes successfully communicated during a predetermined or predefined time interval (such as a time interval between, e.g., 1 and 10 s) to an estimated maximum number of bytes that can be communicated in the predetermined or predefined time interval (the latter of which is sometimes referred to as the ‘capacity’ of a communication channel or link), and/or a ratio of an actual data rate to an estimated data rate (which is sometimes referred to as ‘utilization’).

Although we describe the network environment shown in FIG. 1 as an example, in alternative embodiments, different numbers and/or types of electronic devices can be present. For example, some embodiments can include more or fewer electronic devices. As another example, in other embodiments, different electronic devices can be transmitting and/or receiving packets or frames. In some embodiments, multiple links can be used during communication between electronic devices 110. Consequently, one of electronic devices 110 can perform operations in the communication techniques.

FIG. 3 presents a flow diagram illustrating an example method 300 for providing a GCR BAR. This method can be performed by an electronic device, such as access point 112 in FIG. 1. For example, method 300 can be implemented by an interface circuit in access point 112 in FIG. 1. Note that the communication between the electronic device and a second electronic device (such as electronic device 110-1 in FIG. 1, which can be a station or client that is associated with access point 112) can be compatible with an IEEE 802.11 communication protocol.

During operation, the electronic device can provide, addressed to at least a second electronic device, a GCR BAR (operation 310), where the GCR BAR indicates that the GCR BAR is protected.

Then, the electronic device can receive, associated with the second electronic device, a M-BA (operation 312).

Note that the GCR BAR can include a GCR MU-BAR.

Moreover, the indication can be included in a reserved bit in the GCR BAR. For example, the reserved bit can include bit 0 or at least one of bits 5-11 in a BAR control field. Furthermore, the GCR BAR can indicate a key identifier using the reserved bit.

Additionally, the GCR BAR can include a PN and a MIC. For example, the PN and the MIC can be included in a BAR information field after a GCR group address or after the BAR information field. Note that the BAR information field can include padding after the MIC.

In some embodiments, the M-BA can be protected. Note that the M-BA can include a per AID TID information field identified by a reserved value in an AID TID information subfield and the per AID TID information subfield can include information associated with GCR. The information can include a GCR group address and/or TID information.

Moreover, the second electronic device can be a member in a GCR group.

Furthermore, the GCR BAR can include information about one or more MAC headers of one or more subsequent GCR data frames and the information can include: a valid SN range, a power-management bit, a more data bit, an EOSP bit, or a HT-control field of one or more MAC headers.

In some embodiments, the electronic device can optionally perform one or more additional operations (operation 314). For example, the interface circuit can provide, addressed to at least the second electronic device and before the GCR BAR, an ICF. The ICF can include information about one or more MAC headers of one or more subsequent GCR data frames. For example, the information can include: a valid SN range, a power-management bit, a more data bit, an EOSP bit, or a HT-control field of one or more MAC headers. Additionally, the interface circuit can receive, associated with the second electronic device and in response to the ICF, an ICR. The ICR can be protected. Note that the ICF can include: a multi-user request-to-send frame, a BSRP, a trigger frame, a BAR frame, a block acknowledgment frame or another control frame. In some embodiments, the ICF can be included in an A-MPDU. The ICF can be unicast and can be protected using a key for a GCR group that includes the second electronic device. Moreover, a RA for the ICF or a user information field in the ICF can include a group address of the GCR group.

FIG. 4 presents a flow diagram illustrating an example method 400 for receiving a GCR BAR. This method can be performed by a second electronic device, such as electronic device 110-1 in FIG. 1 (which can be a station or client that is associated with access point 112). For example, method 300 can be implemented by an interface circuit in electronic device 110-1 in FIG. 1. Note that the communication between the second electronic device and an electronic device (such as access point 112 in FIG. 1) can be compatible with an IEEE 802.11 communication protocol.

During operation, the second electronic device can receive, associated with the electronic device, a GCR BAR (operation 410), where the GCR BAR indicates that the GCR BAR is protected.

Then, the interface circuit can provide, addressed to the electronic device, an M-BA (operation 412). The M-BA can be protected.

In some embodiments, the second electronic device can optionally perform one or more additional operations (operation 414). For example, the interface circuit can validate the one or more GCR data frames based at least in part on the information. For example, the validation can be based at least in part on a MIC of an ICF.

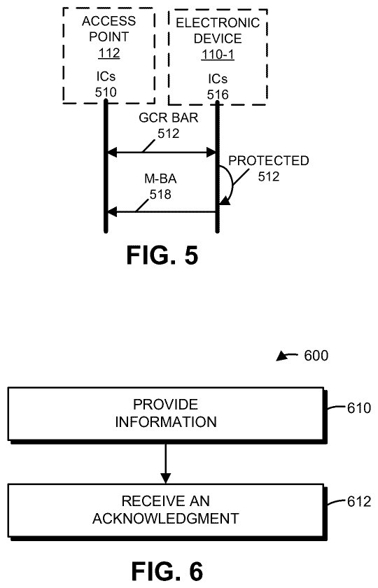

The communication techniques are further illustrated in FIG. 5, which presents a flow diagram illustrating an example of communication between electronic device 110-1 and access point 112. During operation, one or more interface circuits (or interface circuitry) 510 in access point 112 cab provide, addressed to electronic device 110-1, a GCR BAR 512, where GCR BAR 512 indicates that GCR BAR 512 is protected 514.

GCR BAR 512 can be received by one or more interface circuits (or interface circuitry) 516 in electronic device 110-1. Then, the one or more interface circuits 516 can provide, addressed to access point 112, an M-BA 518.

FIG. 6 presents a flow diagram illustrating an example method 600 for providing information. This method can be performed by an electronic device, such as access point 112 in FIG. 1. For example, method 600 can be implemented by an interface circuit in access point 112 in FIG. 1. Note that the communication between the electronic device and a second electronic device (such as electronic device 110-1 in FIG. 1, which can be a station or client that is associated with access point 112) can be compatible with an IEEE 802.11 communication protocol.

During operation, the electronic device can provide, addressed to a second electronic device, the information (operation 610) that indicates the second electronic device remains on an enhanced multi-link single radio (eMLSR) link.

Then, the electronic device can receive, associated with the second electronic device, an acknowledgment (operation 612).

Note that the information can include: a duration during which the second electronic device remains on the eMLSR link; an end of a PPDU for coordination transmission; an end of a current TXOP; or an indication that the second electronic device needs to wait for another frame addressed at least to the second electronic device before the end of the current TXOP. For example, the indication can include a flag in an ICF. In some embodiments, the information can be included in: a trigger frame; or an A-control field of a data or a management frame.

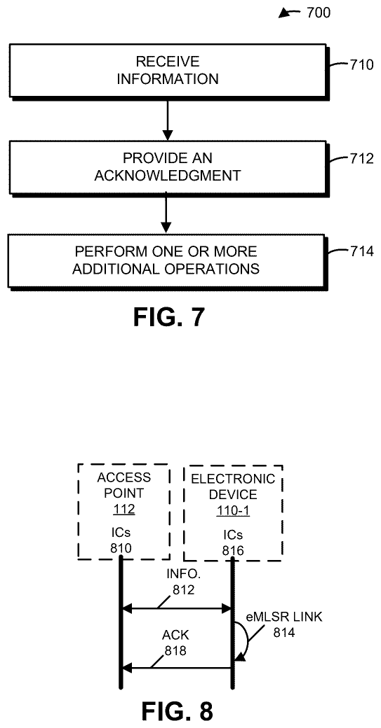

FIG. 7 presents a flow diagram illustrating an example method 700 for receiving information. This method can be performed by a second electronic device, such as electronic device 110-1 in FIG. 1 (which can be a station or client that is associated with access point 112). For example, method 700 can be implemented by an interface circuit in electronic device 110-1 in FIG. 1. Note that the communication between the second electronic device and an electronic device (such as access point 112 in FIG. 1) can be compatible with an IEEE 802.11 communication protocol.

During operation, the second electronic device can receive, associated with the electronic device, the information (operation 710) that indicates the second electronic device remains on an eMLSR link.

Then, the second electronic device can provide, addressed to the electronic device, an acknowledgment (operation 712).

In some embodiments, the second electronic device can optionally perform one or more additional operations (operation 714). For example, the second electronic device can remain on the eMLSR link for a predefined threshold time. When no indication of an incoming PPDU addressed to the second electronic device is detected at the end of the predefined threshold time, the second electronic device can switch to a listening operation.

The communication techniques are further illustrated in FIG. 8, which presents a flow diagram illustrating an example of communication between electronic device 110-1 and access point 112. During operation, one or more interface circuits (or interface circuitry) 810 in access point 112 cab provide, addressed to electronic device 110-1, information 812 that indicates the second electronic device remains on an eMLSR link 814.

Information 812 can be received by one or more interface circuits (or interface circuitry) 816 in electronic device 110-1. Then, the one or more interface circuits 816 can provide, addressed to access point 112, an acknowledgment (ACK) 818.

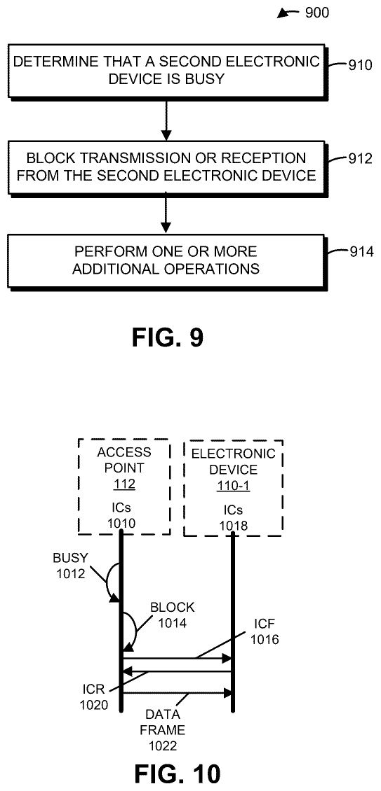

FIG. 9 presents a flow diagram illustrating an example method 900 for selectively blocking transmission or reception. This method can be performed by an electronic device, such as access point 112 in FIG. 1. For example, method 900 can be implemented by an interface circuit in access point 112 in FIG. 1. Alternatively, method 900 can be implemented by an interface circuit in electronic device 110-1 in FIG. 1. Note that the communication between the electronic device and a second electronic device (such as electronic device 110-1 in FIG. 1, which can be a station or client that is associated with access point 112, or access point 112) can be compatible with an IEEE 802.11 communication protocol.

During operation, the electronic device can determine that the second electronic device is busy (operation 910), using peer-to-peer communication, on a first eMLSR link. Then, while the second electronic device is busy on the first eMLSR link, the electronic device can block the transmission to or the reception from the second electronic device (operation 912) using a second eMLSR link.

In some embodiments, the electronic device can optionally perform one or more additional operations (operation 914). For example, before transmitting a data frame on a given eMLSR link that includes the first eMLSR link or the second eMLSR link, the electronic device can provide, addressed to the second electronic device, an ICF.

Moreover, before receiving a data frame on a given eMLSR link that includes the first eMLSR link or the second eMLSR link, the second electronic device can receive the ICF associated with the electronic device. After receiving the ICF, the second electronic device can respond with an ICR.

In some embodiments of methods 300 (FIGS. 3), 400 (FIGS. 4), 600 (FIGS. 6), 700 (FIG. 7), and/or 900, there can be additional or fewer operations. Further, one or more different operations can be included. Moreover, the order of the operations can be changed, and/or two or more operations can be combined into a single operation or performed at least partially in parallel.

The communication techniques are further illustrated in FIG. 10, which presents a flow diagram illustrating an example of communication between electronic device 110-1 and access point 112. During operation, one or more interface circuits (or interface circuitry) 1010 in access point 112 can determine that electronic device 110-1 is busy 1012, using peer-to-peer communication, on a first eMLSR link. Then, while electronic device 110-1 is busy 1012 on the first eMLSR link, access point 112 can block 1014 the transmission to or the reception from electronic device 110-1 on or using a second eMLSR link.

Moreover, before transmitting a data frame 1022 on a given eMLSR link, such as the first eMLSR link, access point 112 can provide, addressed to electronic device 110-1, an ICF 1016. This ICF can be received by one or more interface circuits (or interface circuitry) 1018 in electronic device 110-1. Then, the one or more interface circuits 1018 can provide, addressed to access point 112, an ICR 1020. Next, after receiving ICR 1020, the one or more interface circuits 1010 can provide, addressed to electronic device 110-1, data frame 1022, which can be received by one or more interface circuits 1018.

While communication between the components in FIGS. 5, 8 and 10 is illustrated with unilateral or bilateral communication (e.g., lines having a single arrow or dual arrows), in general a given communication operation can be unilateral or bilateral. Moreover, while operations in FIGS. 5, 8 and 10 are illustrated as being sequential, in some embodiments at least some of the operations can be performed in parallel.

We now further describe embodiments of the disclosed communication techniques. As discussed previously, in an attack, an attacker can move the block acknowledgment window to cause data loss at one or more receivers. For example, fake GCR MU-BAR or data can be injected with an invalid SN, which can befoul or otherwise corrupt the scoreboard and/or can corrupt the reorder buffer, which may prevent the incorrect ordering of the frames and/or can aid in the recovery of the associated content. In order to address these vulnerabilities, the disclosed communication techniques can protect group-addressed data and/or management frames, and can enable secure and fast GCR. Although GCR service is used as an example in the present disclosure, the disclosed communication techniques can also be used to protect group-addressed data and/or management frames that are not associated with a GRC service.

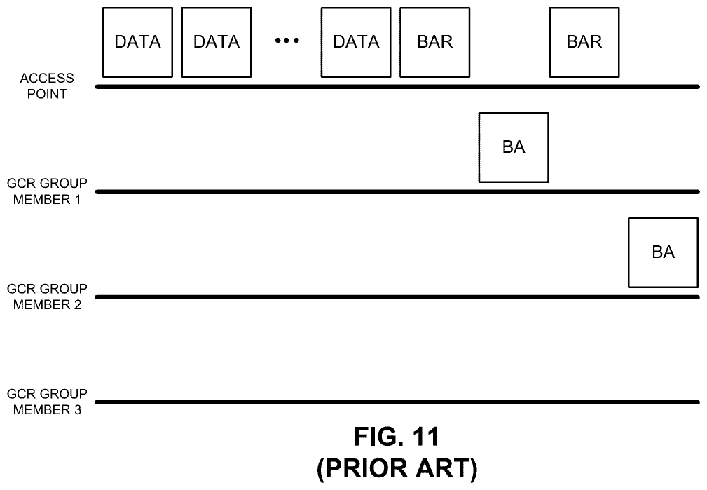

Moreover, as shown in FIG. 11, which presents a drawing illustrating existing communication between electronic devices, in existing or legacy unicast GCR BAR, different members of a GCR group can be polled for block acknowledgments (BAs) following data transmission. In order to protect this communication, a protected GCR BAR that solicits a protected M-BA can be defined. This can prevent an attacker from manipulating the scoreboard with fake data.

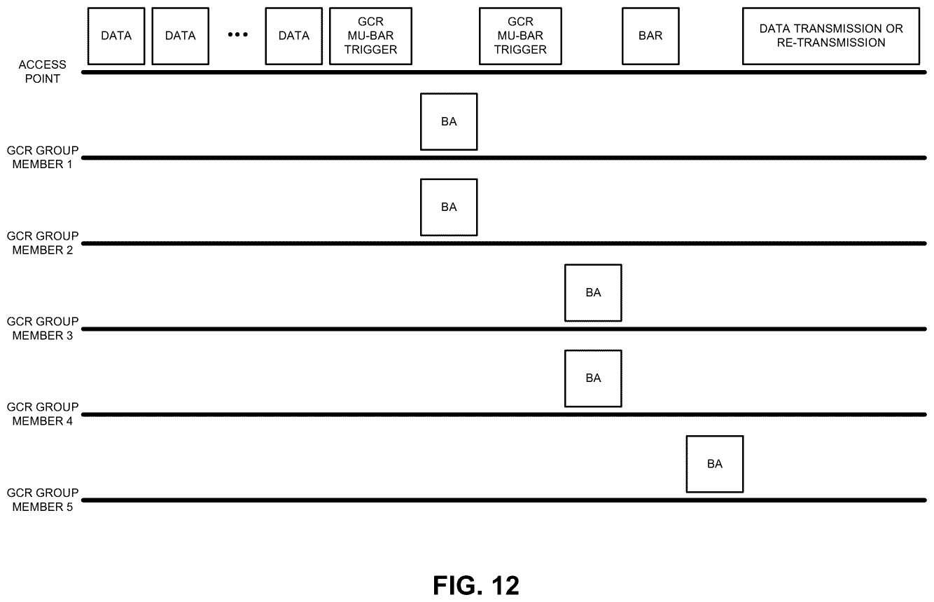

Furthermore, as shown in FIG. 12, which presents a drawing illustrating an example of communication between the electronic devices of FIG. 1 or 2, in some IEEE 802.11 versions (e.g., IEEE 8021ax, IEEE 8021be and/or IEEE 8021bn), a GCR MU-BAR trigger frame can be used to solicit simultaneous block acknowledgments from multiple members of a GCR group (such as GCR group member 1 and GCR group member 2, or GCR group member 3 and GCR group member 4) following data transmission. Alternatively, a GCR BAR can be used to solicit a block acknowledgment from a non-high efficiency station that is a member of the GCR group (such as GCR group member 5). In order to protect this communication, a protected GCR MU-BAR that solicits a protected M-BA can be defined. This can prevent an attacker from manipulating the scoreboard with fake data.

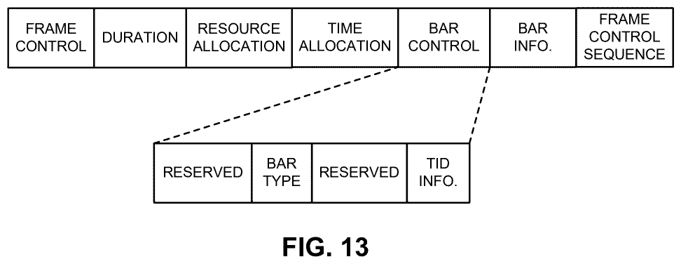

This is shown in FIG. 13, which presents a drawing illustrating an example of a protected GCR BAR or GCR MU-BAR. Notably, FIG. 13 illustrates embodiments of how to protect a unicast GCR BAR. For example, a GCR MU-BAR can be covered by one or more protected trigger frames. A protected GCR BAR can include: frame control field (which can be, e.g., 2 octets), a duration field (which can be, e.g., 2 octets), a receive address field (which can be, e.g., 6 octets), a transmit address field (which can be, e.g., 6 octets), a BAR control field (which can be, e.g., 2 octets), a BAR information field (which can be, e.g., of variable size), and/or a frame control sequence (FCS) field (a receive address (which can be, e.g., 4 octets). Moreover, one or more reserved bits in the BAR control field can be used to indicate whether the frame is a protected GCR BAR and/or to indicate a key identifier. For example, reserved bit 0 (B0) and/or reserved bits 5-11 (B5-B11 or up to seven bits) can be used. In other implementations, one or more other bits can be used. Note that the BAR type (e.g., four bits) can be used to indicate: reserved (BAR type of ‘0’), extended compressed (BAR type of ‘1’), compressed (BAR type of ‘2’), multi-traffic identifier or TID (BAR type of ‘3’), reserved (BAR type of ‘4’ or ‘5’), or GCR (BAR type of ‘6’).

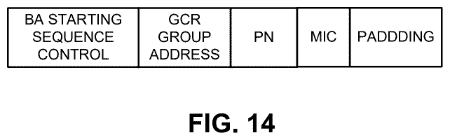

FIG. 14 presents a drawing illustrating an example of a protected GCR BAR or GCR MU-BAR. Notably, FIG. 14 illustrates where to place the protective information, such as the packet number (PN), the message integrity check (MIC), and/or optional padding) within or after the BAR information field of a GCR BAR frame. Notably, the PN, the MIC (which can function like a checksum and can be enabled during association), and/or the optional padding can be included after the GCR group address. A reserved bit in the BAR control field can be used to indicate a protected GCR BAR frame and/or a reserved bit can indicate the key identifier that is used to generate the MIC. Note that either a protected unicast GCR BAR or a protected group-addressed (broadcast) GCR MU-BAR can solicit a protected M-BA (instead of a block acknowledgment or a GCR block acknowledgment), which can be transmitted to the access point. For example, the protected M-BA can include a special per association identifier (AID) TID information field. Furthermore, the AID TID can be identified by a reserved value, e.g., in an AID TID information subfield, to carry information related to GCR, such as the GCR group address and/or TID information (which can be defined for a legacy GCR block acknowledgment). Note that bits 0-15 (or 16 bits) can be used for a block acknowledgment starting sequence control, and bits 16-63 (or 48 bits) can be used for a GCR group address.

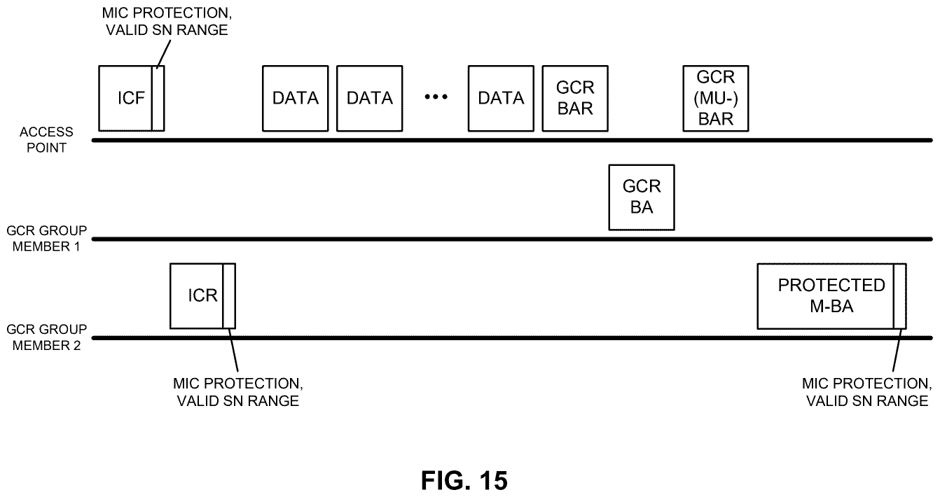

Additionally, FIG. 15 presents a drawing illustrating an example of communication between electronic devices. As shown in FIG. 15, one or more embodiments can be used to protect against attacks on the MAC header of data in GCR. Notably, because a legacy station (such as group member 1) may need to receive GCR data, the GCR data itself cannot be modified to protect the MAC header. Consequently, an attacker can insert a fake MAC header in the data to cause data loss, e.g., by disrupting or corrupting the block acknowledgment window with a fake packet SN.

In order to address these vulnerabilities, an optional protected initial control frame (ICF) can indicate information about the MAC header of the subsequent GCR data. For example, it can indicate a valid SN range, a power management bit (which can indicate a power-save mode in an access point), a more data bit, a number of other data frames, and/or an end of service period (EOSP) bit, such as in a high throughput (HT)-control field of the MAC header, so that a receiver can validate this information using the MIC of the ICF. Note that the ICF can be a multi-user request-to-send (MU-RTS), a buffer status report poll (BSRP), a trigger frame, a BAR frame, a block acknowledgment frame or any protected control frame, e.g., as defined in IEEE 802.11bn or a subsequent IEEE 802.11 standard. When protection is enabled by a station that is a GCR group member (e.g., using a protected ICF): a protected GCR BAR or a protected GCR MU-BAR can be used to solicit a response from the station and the response can be sent in a protected M-BA; and the station can discard GCR data having an SN that is outside of the valid SN range indicated by the protected ICF. The same validation can also be used to discard fake GCR data that have an invalid value, such as an invalid power-management bit, more data bit, EOSP bit, or HT-control field. Note that a station can optionally respond to a protected ICF with an optional initial control response (ICR) frame, which can optionally be a protected ICR. In some embodiments, the protected ICF can be protected using an optional MIC. Furthermore, note that when more than a threshold number of errors are reported to an access point in the optional ICR, the access point can update the key, so that an attacker can no longer generate a valid MIC. Note that group member 2 can be an ultra-high reliability (UHR) station.

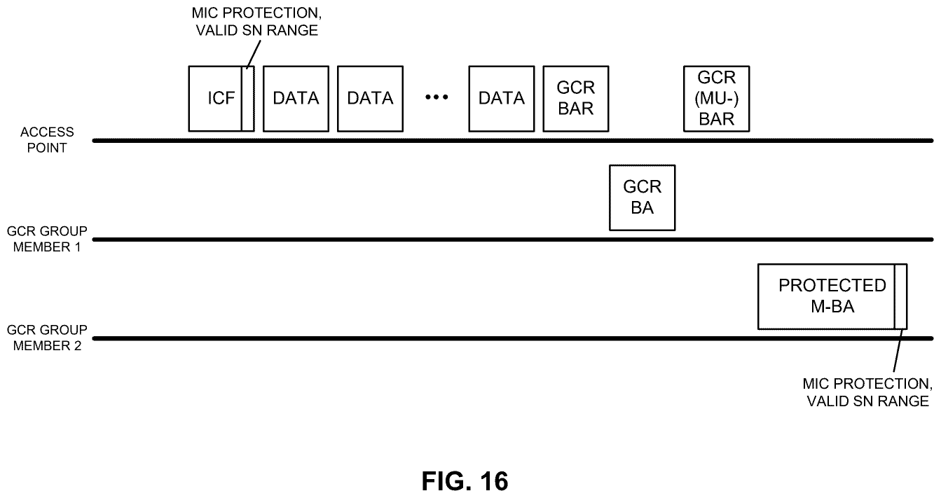

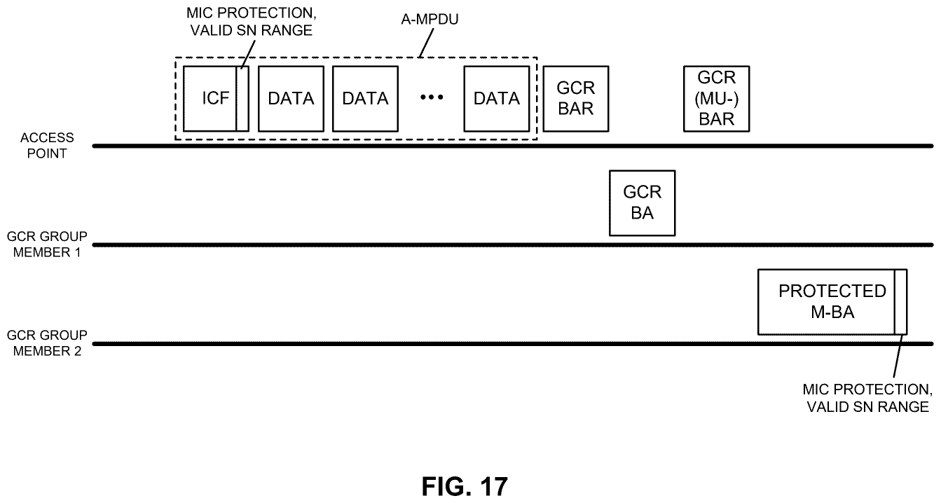

FIGS. 16 and 17 present drawings illustrating examples of communication between electronic devices. For example, as shown in FIG. 16, adjacent frames in the data sequence can be separated by a short interframe space (SIFS), e.g., a separation time (such as SIFS bursting). Moreover, as noted previously, the optional ICR may or may not be protected (e.g., a clear-to-send or CTS frame can be used). Alternatively, as shown in FIG. 17, the ICR may not be present. In these embodiments, the ICF can be grouped with the remaining frames: using SIFS bursting; or aggregated with an aggregate-MAC protocol data unit (A-MPDU). In such an A-MPDU, the ICF can be repeated zero or more times anywhere in the A-MPDU, e.g., for reliability. For example, multiple instances of the ICF can be included back-to-back (adjacent to one another) or can be spread out in the A-MPDU. In some embodiments, the ICF can be positioned at the beginning of the A-MPDU. In FIGS. 16 and 17, note that group member 1 can be a legacy station and group member 2 can be a UHR station.

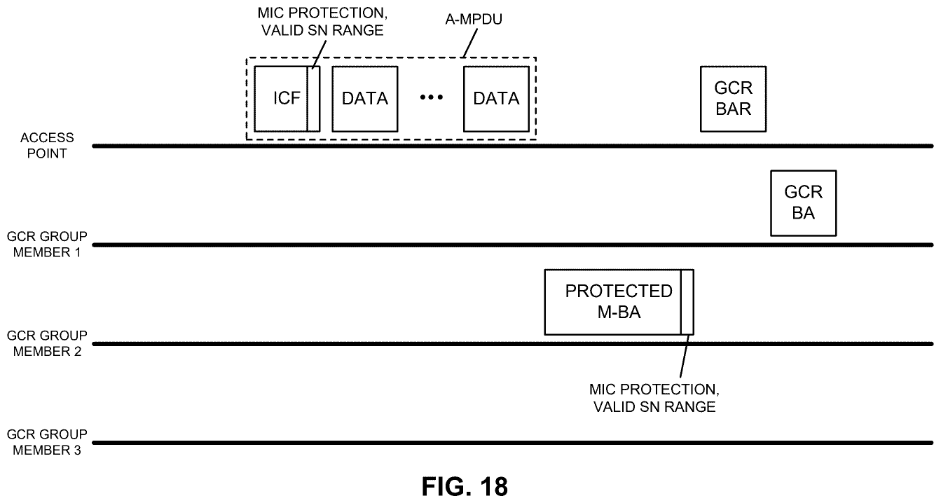

Moreover, as shown in FIG. 18, which presents a drawing illustrating an example of communication between electronic devices, in the embodiments in which the ICF is included in the A-MPDU, the ICF can solicit an immediate response (such as a protected M-BA) from one or more addressed stations that support protected GCR service. This can be performed without requiring a separate BAR. As noted previously, the ICF can be any protected control frame. When the control frame is a unicast frame or is included in a unicast frame (e.g., a GCR BAR frame), in order to allow multiple stations to be able to decode it, the key for a group-addressed frame can be used to protect the ICF. Moreover, the resource allocation (RA) of the unicast frame can also be changed to a group address. Note that a GCR group member can validate the ICF based at least in part on the key for the group-addressed frame. Note that in order to reduce overhead, the ICF can be implemented as a trigger frame for an M-BA, which can reduce overhead. In FIG. 18, note that group member 1 can be a legacy station and group members 2 and 3 can be UHR stations.

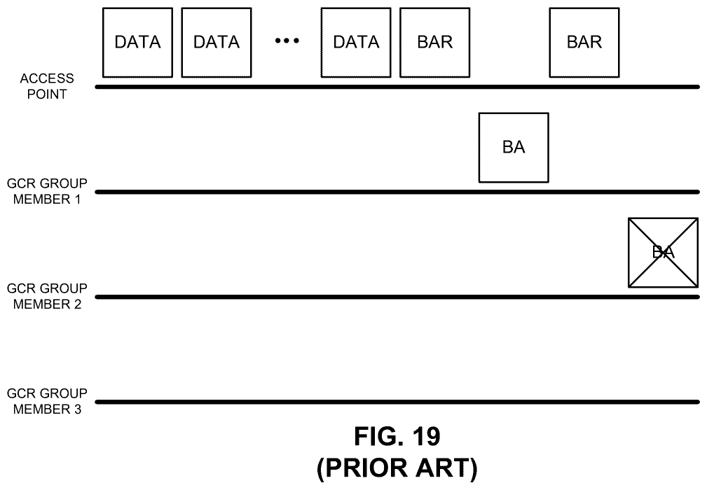

Other embodiments are shown in FIG. 19, which presents a drawing illustrating an example of existing communication between electronic devices. Notably, existing IEEE 802.11be rules have a limitation on enhanced multi-link single radio (eMLSR) operation and may not work well with an eMLSR station. (While IEEE 802.11be allows stations to simultaneously operate on multiple links using multiple radios in a higher-power mode, this can be expensive in terms of power consumption. Instead, a station can have one or more radios in an eMLSR mode. This can allow lower-power listening (or monitoring) until a radio in a higher-power mode is needed.) For example, a non-access point MLD can be switched to the listening operation on the eMLSR link(s). In some instances, the switch can occur after the eMLSR transition delay time most-recently indicated by the non-access point MLD, e.g., when this non-access point station does not detect, within the PPDU corresponding to a physical receive start (PHY-RXSTART) indication (PHY-RXSTART.indication) of an individually addressed frame with the RA equal to the MAC address of the non-access point station affiliated with the non-access point MLD. This may not allow an eMLSR station to take advantage of the low-latency benefit of eMLSR operation from its link diversity. For example, after a BAR is transmitted by an access point, GCR group member 1 can provide a block acknowledgment. However, GCR group member 2, which can be an IEEE 802.11be eMLSR station, may switch to listen mode when this occurs. Therefore, GCR group member 2 can miss a subsequent BAR transmitted by the access point and thus may not provide a block acknowledgment. Stated differently, an access point can send an ICF (such as a BAR) to one or more stations. In response, a station can transition to a higher power mode. When the station receives a frame or a packet that is not intended for the station, the station can transition back to a lower power mode. In the process, however, the station (such as GCR group member 2) can miss a subsequent BAR frame intended for it.

Note that an eMLSR enhancement can be implemented in order to address such scenarios. Notably, eMLSR for data exchange with an access point can include one or more exceptions for when a transition (or switch back) to a listening operation (e.g., low-power mode) is performed. In particular, there can be one or more exceptions with respect to when a non-access point MLD can be switched back to the listening operation on an EMLSR link. In some implementations, this can reduce a chance that the station will switch back too early. For example, an access point can instruct the station to stay on a link longer, e.g., based at least in part on one or more of the following indications: duration information in a trigger frame (such that a non-access point station does not switch back to listen mode during the indicated duration); the more trigger frame (TF) field in a trigger frame (such as, when set to ‘1,’ the non-access point station can wait for a next PPDU from the access point instead of switching back to the listening operation immediately); an end of a PPDU for coordinated transmission (coordinated beam-forming or C-BF, or coordinate spatial reuse or C-SR); an end of an aggregate control (A-control) field of a data frame or a management frame; an end of a current transmit opportunity (TXOP) (as indicated by or in a more data subfield in a frame Control field or an end of service period (EOSP) subfield in a quality-of-service (QoS) control field); when the medium or channel is idle (such as based at least in part on a SIFS, a packet interframe space (PIFS) or a PHY-RXSTART indication); and/or a special user information field in a trigger frame (such as a user information field whose AID12 subfield is set to a currently reserved value, e.g., 2008-2044 or 2047-4094). Note that the special user information field can also have its AID12 subfield set to 2046, indicating an unallocated resource unit (RU) in baseline. In other implementations, other values can be used. The content of this special user information field can instruct one non-access point station (such as when the content includes its AID) or multiple non-access point stations (such as when the content includes a group address or a list of AIDs for the stations). The content can also indicate a target SN for the non-access point station(s) to receive before the non-access point station(s) switch back to the listening operation on the eMLSR link(s).

Moreover, note that a non-access point station can switch back to the listening operation after one or more of the above conditions are met, or when the station does not detect the PHY-RXSTART indication within a threshold time (such as the sum of an aSIFSTime, an aSlotTime, and an aRxPHYStartDelay in IEEE 802.11be), it can switch back to listening mode.

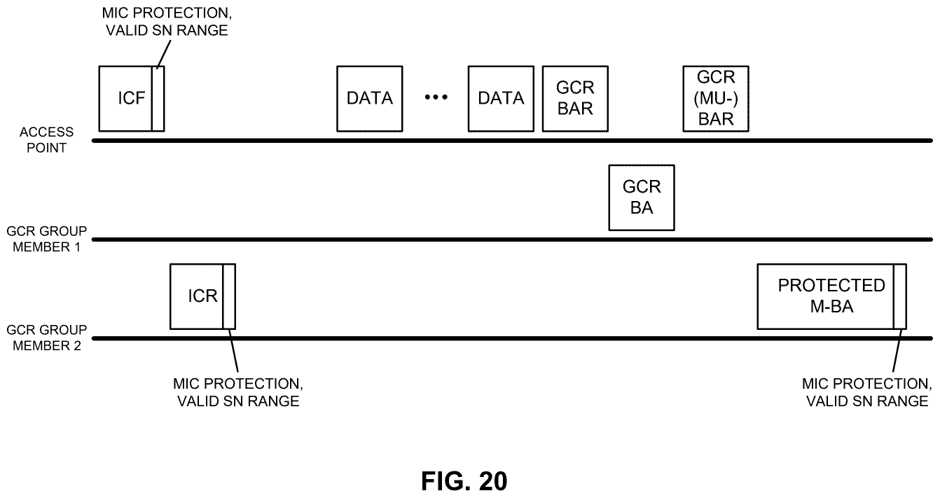

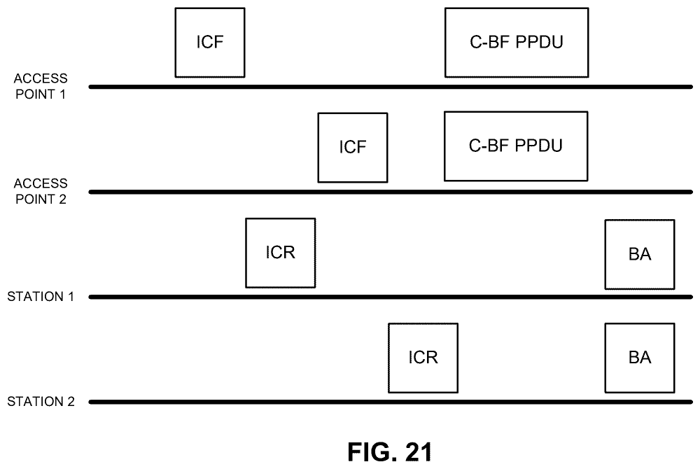

FIGS. 20 and 21 present drawings illustrating examples of communication between electronic devices. Notably, FIG. 20 shows that one or more of the transmissions from the access point (such as the protected ICF, the data, the GCR BAR and/or the protected GCR BAR or MU-BAR) may include one or more of the disclosed indications. In response to the GCR-BAR, GCR group member 1 (which may be a legacy station) can provide a GCR block acknowledgment. GCR group member 2 (which may be a UHR station) can provide a protected ICR in response to the protected ICF. Furthermore, GCR group member 2 can wait on the link, e.g., based at least in part on one or more of the disclosed indications, until it receives a protected GCR BAR or GCR MU-BAR. Additionally, GCR group member 2 can provide a protected M-BA, e.g., in response.

Alternatively or additionally, access point 1 can provide a first ICF that includes one or more of the disclosed indications. The ICF can be followed by a first C-BF PPDU. Similarly, access point 2 can provide a second ICF that includes one or more of the disclosed indications. The second ICF can be followed by a second C-BF PPDU. Note that in some instances the first C-BF PPDU and the second C-BF PPDU can be communicated concurrently, e.g., based at least in part on coordinated beam-forming or coordinated spatial reuse.

As shown in FIG. 21, station 1, which is associated with access point 1, can provide a first ICR, e.g., in response to the first ICF from access point 1. Station 1 can remain on the link, e.g., based at least in part on one or more indications in the first ICF (which were discussed previously) or a second ICF from access point 2. After the first coordinated-beamforming (C-BF) PPDU, station 1 can provide a first block acknowledgment. Station 2, which is associated with access point 2, can provide a second ICR, e.g., in response to the second ICF from access point 2. Station 2 can remain on the link, e.g., based at least in part on one or more indications in an ICF (which were discussed previously). After the second C-BF PPDU, station 2 can provide a second block acknowledgment. Note that in some implementations the first block acknowledgment and the second block acknowledgment can be communicated concurrently.

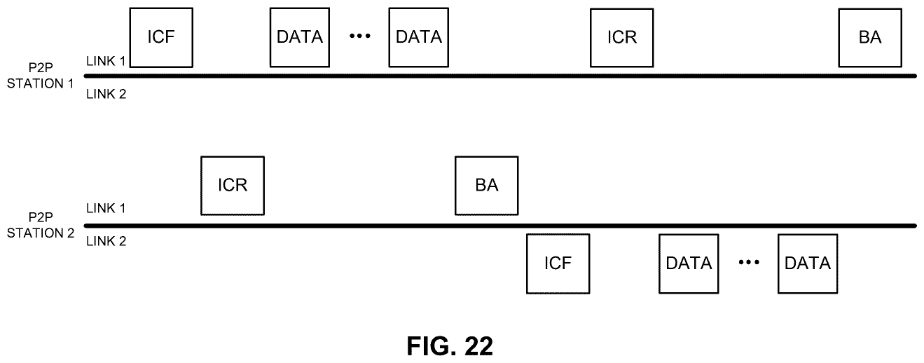

As shown in FIG. 22, which presents a drawing illustrating an example of communication between electronic devices, in some embodiments the communication techniques can provide an enhancement to eMLSR for data exchange on a peer-to-peer (P2P) link. An ICF/ICR can be used at the beginning of a TXOP for the data exchange for a peer-to-peer link. The data exchange can be allowed on any link between two eMLSR stations for low-latency data delivery (including GCR). When a transmitter determines that a receiver is busy on one eMLSR link for peer-to-peer communication, the transmitter may not transmit to the receiver on another eMLSR link. For example, when a transmitter determines that a receiver is using eMLSR link 1, the transmitter may not use eMLSR link 2.

While the proceeding discussion illustrated the communication techniques using a GCR service, more generally the communication techniques may be used to protect information during wireless communication of group-addressed frames using one or more other communication protocols or services. For example, the group-addressed frames can include: video streaming, audio streaming, group-addressed transmissions without retries, etc.

Moreover, while the proceeding embodiments illustrated the communication techniques with a sequence of frames that includes a GCR BAR or a GCR MU-BAR, in other embodiments of the communication techniques the information in the communication techniques (such as a valid SN of GCR data frame(s)) can be included in an initial control frame (such as in the MAC header) without the sequence including the GCR BAR or the GCR MU-BAR.

In some embodiments, the communication techniques can be implemented in a physical layer and/or a MAC layer.

Note that the formats of packets or frames communicated during the communication techniques can include more or fewer bits, subfields or fields. Alternatively or additionally, the position of information in these packets or frames can be changed. Thus, the order of the subfields or fields can be changed.

While the preceding embodiments illustrate embodiments of the communication techniques using frequency sub-bands, in other embodiments the communication techniques can involve the concurrent use of different temporal slots, and/or or a combination of different frequency sub-bands, different frequency bands and/or different temporal slots. In some embodiments, the communication techniques can use OFDMA.

Moreover, while the preceding embodiments illustrated the use of Wi-Fi during the communication techniques, in other embodiments of the communication techniques Bluetooth or Bluetooth Low Energy is used to communicate at least a portion of the information in the communication techniques. Furthermore, the information communicated in the communication techniques can be communicated or can occur in one or more frequency bands, including: 900 MHz, a 2.4 GHz frequency band, a 5 GHz frequency band, a 6 GHz frequency band, a 60 GHz frequency band, a Citizens Broadband Radio Service (CBRS) frequency band, a band of frequencies used by LTE or another data communication protocol, etc.

As described herein, aspects of the present technology can include the gathering and use of data available from various sources, e.g., to improve or enhance functionality. The present disclosure contemplates that in some instances, this gathered data can include personal information data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital signs measurements, medication information, exercise information), date of birth, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data can be governed by federal and/or state laws, such as the Health Insurance Portability and Accountability Act (HIPAA); whereas health data in other countries can be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configurable to allow users to selectively “opt in” or “opt out” of participation in the collection of personal information data, e.g., during registration for services or anytime thereafter. In addition to providing “opt in” and “opt out” options, the present disclosure contemplates providing notifications relating to the access or use of personal information. For instance, a user can be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification can be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure can broadly cover use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

We now describe embodiments of an electronic device. FIG. 23 presents a block diagram of an electronic device 2300 (which can be a cellular telephone, a smartwatch, an access point, a wireless speaker, an IoT device, another electronic device, etc.) in accordance with some embodiments. This electronic device includes processing subsystem 2310, memory subsystem 2312 and networking subsystem 2314. Processing subsystem 2310 includes one or more devices configured to perform computational operations. For example, processing subsystem 2310 can include one or more microprocessors, application-specific integrated circuits (ASICs), microcontrollers, graphics processing units (GPUs), programmable-logic devices, and/or one or more digital signal processors (DSPs).

Memory subsystem 2312 includes one or more devices for storing data and/or instructions for processing subsystem 2310, and/or networking subsystem 2314. For example, memory subsystem 2312 can include dynamic random access memory (DRAM), static random access memory (SRAM), a read-only memory (ROM), flash memory, and/or other types of memory. In some embodiments, instructions for processing subsystem 2310 in memory subsystem 2312 include: program instructions or sets of instructions (such as program instructions 2322 or operating system 2324), which can be executed by processing subsystem 2310. For example, a ROM can store programs, utilities or processes to be executed in a non-volatile manner, and DRAM can provide volatile data storage, and can store instructions related to the operation of electronic device 2300. Note that the one or more computer programs can constitute a computer-program mechanism, a computer-readable storage medium or software. Moreover, instructions in the various modules in memory subsystem 2312 can be implemented in: a high-level procedural language, an object-oriented programming language, and/or in an assembly or machine language. Furthermore, the programming language can be compiled or interpreted, e.g., configurable or configured (which can be used interchangeably in this discussion), to be executed by processing subsystem 2310. In some embodiments, the one or more computer programs are distributed over a network-coupled computer system so that the one or more computer programs are stored and executed in a distributed manner.

In addition, memory subsystem 2312 can include mechanisms for controlling access to the memory. In some embodiments, memory subsystem 2312 includes a memory hierarchy that includes one or more caches coupled to a memory in electronic device 2300. In some of these embodiments, one or more of the caches is located in processing subsystem 2310.

In some embodiments, memory subsystem 2312 is coupled to one or more high-capacity mass-storage devices (not shown). For example, memory subsystem 2312 can be coupled to a magnetic or optical drive, a solid-state drive, or another type of mass-storage device. In these embodiments, memory subsystem 2312 can be used by electronic device 2300 as fast-access storage for often-used data, while the mass-storage device is used to store less frequently used data.

Networking subsystem 2314 includes one or more devices configured to couple to and communicate on a wired and/or wireless network (i.e., to perform network operations), such as: control logic 2316, one or more interface circuits (or interface circuitry) 2318 and a set of antennas 2320 (or antenna elements) in an adaptive array that can be selectively turned on and/or off by control logic 2316 to create a variety of optional antenna patterns or ‘beam patterns.’ Alternatively, instead of the set of antennas, in some embodiments electronic device 2300 includes one or more nodes 2308, e.g., a pad or a connector, which can be coupled to the set of antennas 2320. Thus, electronic device 2300 may or may not include the set of antennas 2320. For example, networking subsystem 2314 can include a Bluetooth™ networking system, a cellular networking system (e.g., a 3G/4G/5G network such as UMTS, LTE, etc.), a universal serial bus (USB) networking system, a networking system based on the standards described in IEEE 802.12 (e.g., a Wi-Fi® networking system), an Ethernet networking system, and/or another networking system.

In some embodiments, networking subsystem 2314 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

Networking subsystem 2314 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 2300 can use the mechanisms in networking subsystem 2314 for performing simple wireless communication between the electronic devices, e.g., transmitting advertising or frame frames and/or scanning for advertising frames transmitted by other electronic devices.

Within electronic device 2300, processing subsystem 2310, memory subsystem 2312 and networking subsystem 2314 are coupled together using bus 2328 that facilitates data transfer between these components. Bus 2328 can include an electrical, optical, and/or electro-optical connection that the subsystems can use to communicate commands and data among one another. Although only one bus 2328 is shown for clarity, different embodiments can include a different number or configuration of electrical, optical, and/or electro-optical connections among the subsystems.

In some embodiments, electronic device 2300 includes a display subsystem 2326 for displaying information on a display, which can include a display driver and the display, such as a liquid-crystal display, a multi-touch touchscreen, etc. Display subsystem 2326 can be controlled by processing subsystem 2310 to display information to a user (e.g., information relating to incoming, outgoing, or an active communication session).

Moreover, electronic device 2300 can also include a user-input subsystem 2330 that allows a user of the electronic device 2300 to interact with electronic device 2300. For example, user-input subsystem 2330 can take a variety of forms, such as: a button, keypad, dial, touch screen, audio input interface, visual/image capture input interface, input in the form of sensor data, etc.

Electronic device 2300 can be (or can be included in) any electronic device with at least one network interface. For example, electronic device 2300 can include: a cellular telephone or a smartphone, a tablet computer, a laptop computer, a notebook computer, a personal or desktop computer, a netbook computer, a media player device, a wireless speaker, an IoT device, an electronic book device, a MiFi® device, a smartwatch, a wearable computing device, a portable computing device, a consumer-electronic device, a vehicle, a door, a window, a portal, an access point, a router, a switch, communication equipment, test equipment, as well as any other type of electronic computing device having wireless communication capability that can include communication via one or more wireless communication protocols.

Although specific components are used to describe electronic device 2300, in alternative embodiments, different components and/or subsystems can be present in electronic device 2300. For example, electronic device 2300 can include one or more additional processing subsystems, memory subsystems, networking subsystems, and/or display subsystems. Additionally, one or more of the subsystems may not be present in electronic device 2300. Moreover, in some embodiments, electronic device 2300 can include one or more additional subsystems that are not shown in FIG. 23. In some embodiments, electronic device can include an analysis subsystem that performs at least some of the operations in the communication techniques. Also, although separate subsystems are shown in FIG. 23, in some embodiments some or all of a given subsystem or component can be integrated into one or more of the other subsystems or component(s) in electronic device 2300. For example, in some embodiments program instructions 2322 are included in operating system 2324 and/or control logic 2316 is included in the one or more interface circuits 2318.

Moreover, the circuits and components in electronic device 2300 can be implemented using any combination of analog and/or digital circuitry, including: bipolar, PMOS and/or NMOS gates or transistors. Furthermore, signals in these embodiments can include digital signals that have approximately discrete values and/or analog signals that have continuous values. Additionally, components and circuits can be single-ended or differential, and power supplies can be unipolar or bipolar.

An integrated circuit can implement some or all of the functionality of networking subsystem 2314. This integrated circuit can include hardware and/or software mechanisms that are used for transmitting wireless signals from electronic device 2300 and receiving signals at electronic device 2300 from other electronic devices. Aside from the mechanisms herein described, radios are generally known in the art and hence are not described in detail. In general, networking subsystem 2314 and/or the integrated circuit can include any number of radios. Note that the radios in multiple-radio embodiments function in a similar way to the described single-radio embodiments.

In some embodiments, networking subsystem 2314 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein includes receiving signals from other electronic devices and possibly performing one or more processing operations on the received signals).

In some embodiments, an output of a process for designing the integrated circuit, or a portion of the integrated circuit, which includes one or more of the circuits described herein can be a computer-readable medium such as, for example, a magnetic tape or an optical or magnetic disk. The computer-readable medium can be encoded with data structures or other information describing circuitry that can be physically instantiated as the integrated circuit or the portion of the integrated circuit. Although various formats can be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques can be used. Thus, the communication techniques can be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments can be performed in hardware, in software or both. For example, at least some of the operations in the communication techniques can be implemented using program instructions 2322, operating system 2324 (such as a driver for an interface circuit in networking subsystem 2314) or in firmware in an interface circuit networking subsystem 2314. Alternatively or additionally, at least some of the operations in the communication techniques can be implemented in a physical layer, such as hardware in an interface circuit or interface circuitry in networking subsystem 2314. In some embodiments, the communication techniques are implemented, at least in part, in a MAC layer and/or in a physical layer in an interface circuit in networking subsystem 2314.

Note that the use of the phrases ‘capable of,’ ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

Moreover, while the preceding embodiments illustrated the use of wireless signals in one or more bands of frequencies, in other embodiments of the communication techniques electromagnetic signals in one or more different frequency bands are used. For example, these signals can be communicated in one or more bands of frequencies, including: a microwave frequency band, a radar frequency band, 900 MHz, 2.4 GHz, 5 GHz, 6 GHz, 60 GHz, and/or a band of frequencies used by a Citizens Broadband Radio Service or by LTE.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein can be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An electronic device, comprising:
an antenna node configured to communicatively couple to an antenna; and
an interface circuit, communicatively coupled to the antenna node, configured to communicate with a second electronic device, wherein the interface circuit is configured to:
provide, addressed to at least the second electronic device, a groupcasting with retries (GCR) block acknowledgment request (BAR), wherein the GCR BAR indicates that the GCR BAR is protected.

2. The electronic device of claim 1, wherein the GCR BAR comprises a GCR multi-user BAR (MU-BAR).

3. The electronic device of claim 1, wherein the indication is included in a reserved bit in the GCR BAR.

4. The electronic device of claim 1, wherein the GCR BAR indicates a key identifier using the reserved bit.

5. The electronic device of claim 1, wherein the GCR BAR comprises a packet number (PN) and a message integrity check (MIC).

6. The electronic device of claim 5, wherein the PN and the MIC are included in a BAR information field after a GCR group address or after the BAR information field.

7. The electronic device of claim 5, wherein the BAR information field comprises padding after the MIC.

8. The electronic device of claim 1, wherein the interface circuit is configured to receive, associated with the second electronic device, a multi-station block acknowledgment (M-BA).

9. The electronic device of claim 8, wherein the M-BA is protected.

10. The electronic device of claim 8, wherein the M-BA comprises a per association identifier (AID) traffic identifier (TID) information field identified by a reserved value in an AID TID information subfield and the per AID TID information subfield comprises information associated with GCR.

11. The electronic device of claim 10, wherein the information comprises a GCR group address, TID information or both.

12. The electronic device of claim 1, wherein the second electronic device is a member in a GCR group.

13. The electronic device of claim 1, wherein the GCR BAR comprises information about one or more media access control (MAC) headers of one or more subsequent GCR data frames and the information comprises a valid sequence number (SN) range, a power-management bit, a more data bit, an end of service period (EOSP) bit, or a high throughput (HT)-control field of one or more media access control (MAC) headers.

14. A method for providing a groupcasting with retries (GCR) block acknowledgment request (BAR), comprising:
by an electronic device:
providing, addressed to at least a second electronic device, the GCR BAR, wherein the GCR BAR indicates that the GCR BAR is protected; and
receiving, associated with the second electronic device, a multi-station block acknowledgment (M-BA).

15. The method of claim 14, wherein the GCR BAR comprises a GCR multi-user BAR (MU-BAR).

16. The method of claim 14, wherein the M-BA is protected.

17. A second electronic device, comprising:
an antenna node configured to communicatively couple to an antenna; and
an interface circuit, communicatively coupled to the antenna node, configured to communicate with an electronic device, wherein the interface circuit is configured to:
receive, associated with the electronic device, a groupcasting with retries (GCR) block acknowledgment request (BAR), wherein the GCR BAR indicates that the GCR BAR is protected.

18. The second electronic device of claim 17, wherein the interface circuit is configured to provide, addressed to the electronic device, a multi-station block acknowledgment (M-BA).

19. The second electronic device of claim 18, wherein the M-BA is protected.

20. The second electronic device of claim 17, wherein the interface circuit is configured to validate the one or more GCR data frames based at least in part on the information.
